(19) United States
(12) Patent Application Publication
(10) Pub. No.: US 2017/0205356 A1
(43) Pub. Date: Jul. 20, 2017

(54) SYSTEM AND APPARATUS FOR A WIRELESS FLUID ANALYZER

(71) Applicants: Robert ASSIMITI, Marietta, GA (US); CENTERO LLC, Marietta, GA (US)

(72) Inventors: Robert Assimiti, Marietta, GA (US); Rares Ivan, Marietta, GA (US); Ion Toma, Marietta, GA (US)

(73) Assignee: CENTERO LLC, Marietta, GA (US)

(21) Appl. No.: 15/326,430

(22) PCT Filed: Jul. 14, 2015
(86) PCT No.: PCT/US2015/040267

§ 371 Date: Jan. 13, 2017

Related U.S. Application Data
(60) Provisional application No. 62/024,224, filed on Jul. 14, 2014.

(51) Int. Cl. G01N 21/78

(52) U.S. Cl. CPC G01N 21/78; G01N 2201/0221

(57) ABSTRACT

This invention discloses a handheld, portable fluid analyzer apparatus and system that allows for in-home or in-field chemical and physical analysis of various fluids. The fluid analyzer apparatus is portable and consists of an electronic reader and a cup used for collection of the fluid sample that is outfitted with various cartridges. The electronic reader uses a plurality of sensing methods in order to analyze the sampled fluid without coming in contact with the fluid The system consists of the apparatus which communicates with a server via a mobile device, router or Gateway. The apparatus utilizes a plurality of wireless communication methods to relay application specific and device management data to a server.

### TECHNICAL FIELD

The present invention relates to a handheld, fluid analyzer that performs measurements and provides instantaneous results of various chemical and physical properties of various types of fluids without coming in contact with the fluid, and transmits the data to a server utilizing wireless communications.

### BACKGROUND ART

Current means for quantitative and qualitative chemical analysis of fluids rely on a user collecting a sample and utilizing test kits based on reagent strips that give a colorimetric indication of the levels of various parameters or interest. These are typically very inaccurate in particular when it comes to quantitative analysis since they involve a user comparing the color of reagent pads to a colorimetric chart. Obtaining highly accurate quantitative and reliable qualitative measurements rely on a sample that is collected and then sent to a laboratory or a location where additional testing equipment is available in order to perform the analysis.

Current means for quantitative physical analysis or a fluid such as temperature, turbidity and conductivity are based on utilizing measurement equipment that typically is in contact with the fluid.

An assistant uses expensive and sophisticated machinery in order to obtain the results of interest. The results are then transmitted to the interested party. This is a very inefficient, time consuming and expensive process especially when related to the analysis of bodily fluids such as urine or saliva. It also typically involves direct contact with the fluid and implicitly contamination of the equipment and personnel used to test the samples.

Current means for quantitative and qualitative chemical and physical analysis of fluids use different types of analyzers, depending on the type of fluid tested and the parameters of interest.

Hence, there is a need to provide an alternate approach that allows users to analyze various fluids such as water, urine and saliva in the comfort of her or his home or on the go, without having to rely on time consuming and costly trips to a location that provides such services. This alternate approach should provide the user with instantaneous results that are also transmitted to a remote device or server for analysis, visualization, trending and storage. The analysis process should also keep the sample fluid fully contained, hence excluding any contamination of the equipment used and the person performing the tests. The same universal reader is used for the analysis of various fluids including but not limited to water, urine and saliva.

### SUMMARY OF INVENTION

The invention is directed to a handheld, portable fluid analyzer that uses a plurality of sensing methods to provide instantaneous measurement for various parameters of interest without coming in contact with the fluid that is being measured.

The apparatus is composed of an electronic reader that includes various sensors and a cup that is outfitted with a cartridge that allows the reader to measure the parameters of interest.

The invention is a multi-purpose analyzer that is used to measure parameters of interest of many types of fluids including but not limited to water, urine or saliva using the same reader but different types of cartridges.

The reader is outfitted with a combination of sensing methods including color, light intensity, conductivity and infrared sensors as well as CMOS or CCD imaging sensors.

The reader uses different wireless communications technologies to exchange data with an application that resides on a remote server that is part of an IPv4 or IPv6 wide area communications infrastructure. The application residing on the server allows an end user to manage the devices, visualize, store, trend and analyze the data received and allows other third party applications to access the data via application specific software interfaces.

A point-to-point wireless connection is used by the reader to communicate with a mobile device that hosts an application that exchanges data with the server. The application running on the mobile device also allows the user to manage, visualize, store, trend and analyze the data received from the readers.

A point-to-point wireless connection is used by the reader to exchange data with the server via a router.

The reader can also communicate with other wireless devices that are part of a multi-hop mesh network that is connected to a server via one or multiple gateways.

Various objects, features, aspects, and advantages of the present invention will become more apparent from the following detailed description of preferred embodiments of the invention, along with the accompanying drawings.

### BRIEF DESCRIPTION OF THE DRAWINGS

Many aspects of the invention disclosed can be better understood with reference to the following drawings in which like numerals represent like components throughout the several views. The components in the drawing are not presented to scale, emphasis instead being placed upon illustrating the functioning of the invention disclosed.

FIG. 1 shows an exploded view of the subcomponents of the fluid analyzer apparatus;

FIG. 2 is a top view of the cartridge subcomponent of the fluid analyzer apparatus;

FIG. 3 is a bottom view of the electronic reader subcomponent of the fluid analyzer apparatus;

FIG. 4 is a topology diagram of the fluid analyzer system where the electronic reader communicates wirelessly with a mobile device or a router;

FIG. 5 is a topology diagram of the fluid analyzer system where the electronic reader communicates with other wireless nodes that are part of a multi-hop mesh network.

### DESCRIPTION OF EMBODIMENTS

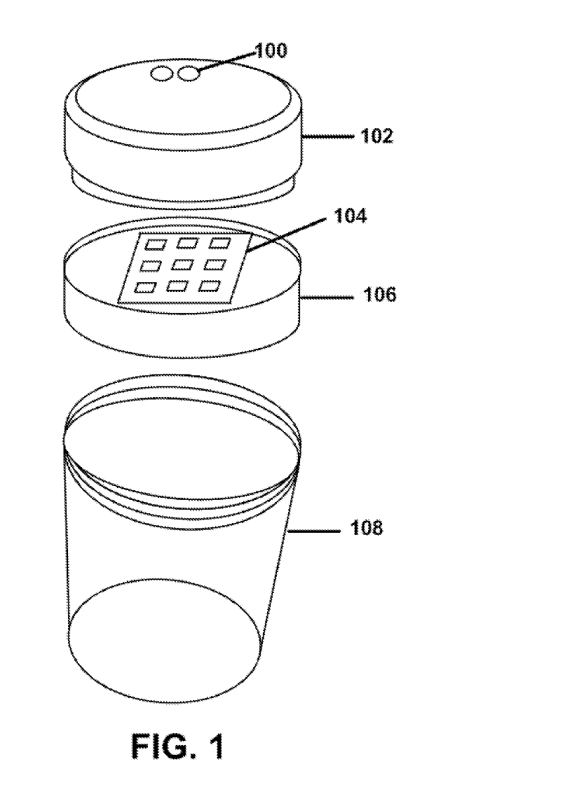

The invention is an apparatus and a system that measures qualitative and quantitative chemical and physical properties of various fluids. Turning to the drawings in which reference characters indicate corresponding elements throughout the several views, attention is first directed to FIG. 1 which shows and exploded view of the subcomponents of the fluid analyzer apparatus. The apparatus consists of a sample collection cup 108, outfitted with a cartridge 106 that forms the lid of the cup 108 and an electronic reader 102.

A fluid sample is collected in the cup that is sealed by cartridge 106 by securing the cartridge to the cup 108 using a thread. The top of the cartridge 106 hosts a fluid sampling area 104 that is composed of a combination of chemical reagent pads as well as other features that allow measuring various parameters of interest. The configuration of the sampling area 104 is cartridge specific and depends on the type of fluid under observation as well as the chemical and physical parameters of interest for a particular application.

Once the fluid sampled is collected in cup 108, the cup it tilted for a few seconds allowing the fluid to react with the chemical reagent pads and to enter various compartments present in sampling area 104.

An electronic reader 102 that hosts a plurality of sensors and sensing methods is placed on top of the cartridge in alignment with the reagent pads and features embedded in sensing area 104. A switch 100 present on top of the electronic reader is activated by the user which commands the electronic reader to take the measurements of interest.

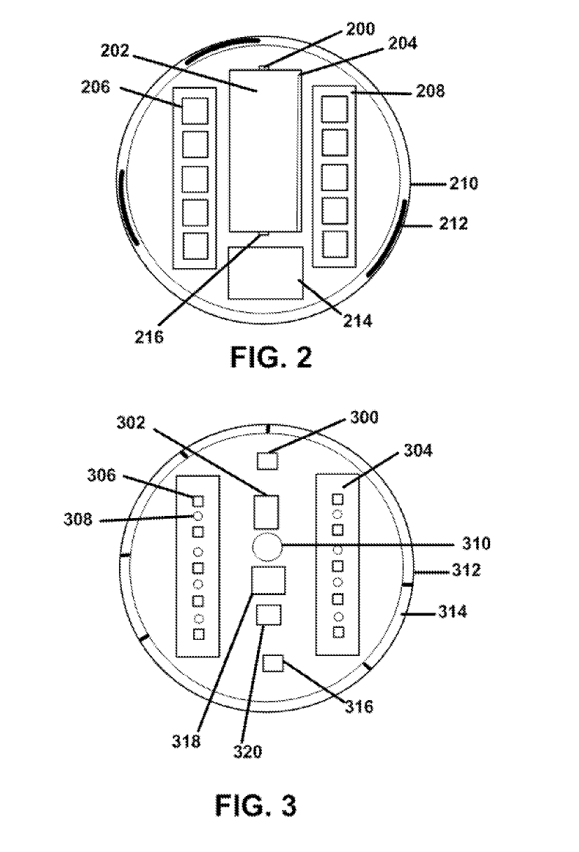

FIG. 2 shows a top view of cartridge 106. A plurality of chemical reagent pads and features that allow measuring various parameters of interest are shown. Chemical reagent pads such as 206 react with the fluid and change color based on the amount or concentration of the quantitative or qualitative parameter measured. The embodiment of cartridge 210 depicted in FIG. 2 hosts two rows of chemical reagent pads such as 208. Chamber 202 embedded in the cartridge traps a small sample of the fluid by allowing the fluid to enter the chamber through a lateral slit 204. The top of chamber 202 is transparent and the bottom part of chamber 202 is coated with a reflective coat. Chamber 202 is also outfitted with two embedded metal electrodes 200 and 216 that come in contact with the sample fluid trapped in the chamber. The cartridge also hosts a transparent window 214 through which the sampled fluid present in the cup is visible.

The top of the reagent pads, chamber 202 and window 214 are made of a transparent, crystalline fluoropolymer material with high luminous transmittance and low refractive indices such as fluorinated ethylene propylene (FEP), polytetrafluoroethylene (PTFE) or perfluoroalkoxy alkane (PFA) or a material with similar properties. The rest of the cartridge top, except electrode contacts 200 and 216 is coated in black, ensuring that light it not reflected off the top of the cartridge. This allows the electronic reader 312 to read the quantitative and qualitative parameters of interest without having contact with the sampled fluid. This also ensures that the electronic reader 312 and the user performing the measurements are not contaminated with the sampled fluid.

The top of the cartridge 210 also includes three protrusions such as 212 that mate with three intrusions such as 314 present on the electronic reader 312. These ensure proper alignment of the features present on the top of the cartridge 210 with sensors present on the bottom of the electronic reader 312. The protrusions and mating intrusions are spaced unequally relative to each other allowing for precise and unique alignment of the cartridge 210 with the electronic reader 312. The protrusions and mating intrusions are also sized to where the cartridge 210 and the electronic reader 312 mate with minimum or no external light entering the space between the mated components.

Cartridges may include a different number of chemical reagent pads and combinations of different features depending on the fluid sampled and the parameters of interest for a particular type of application.

FIG. 3 shows the bottom view of the electronic reader 10. The electronic reader hosts a plurality of sensors that are used in conjunction with various features present in cartridge 210. Color sensors such as 306 are used in tandem with LED light sources such as 308 in order to read the color of the reagent pads such as 206. The LED light sources such as 308 used to detect the color are white LEDs that emit light that has a color temperature in the range of 4500K-5500K in order to emulate daylight. The light emitted by the LED light sources is reflected off the surface of the reagent pad and allows color sensors such as 206 to detect the color of the pad. The electronic reader 312 hosts two rows of color sensors and LED light sources such as 304 allowing it to read up to 10 reagent pads which are arranged in two rows of 5 single pads.

The electronic reader 312 includes two embedded metallic contacts 300 and 320 that are appropriately positioned and aligned to come in contact with electrodes 200 and 216 embedded in cartridge 210. The contacts are used to inject a current in the sample fluid trapped in chamber 202 in order to measure the conductivity of the sample fluid. The conductivity of the fluid is measured using a high-precision ADC converter present in the electronic reader 312.

Light intensity sensor 302 is used in conjunction with the light emitting source 310 in order to measure the turbidity of the fluid trapped in chamber 202. The light emitting source is a white LED that emits light that has a color temperature in the range of 4500K-5500K in order to emulate daylight. The light enters chamber 202 through the transparent polymer material and is reflected off the bottom side of chamber 202 which is coated with a reflective coating. Light intensity sensor 302 measures that intensity of the light reflected which is proportional with the turbidity of the sample fluid.

CCD or CMOS image sensor 318 is used to capture high resolution images of the fluid trapped in chamber 202.

Infrared sensor 316 is used to measure the temperature of the sample fluid. Infrared light enters sample cup 108 through window 214 and bounces off the surface of the sample fluid. The infrared sensor uses the reflections in order to accurately assess the temperature of the sample fluid.

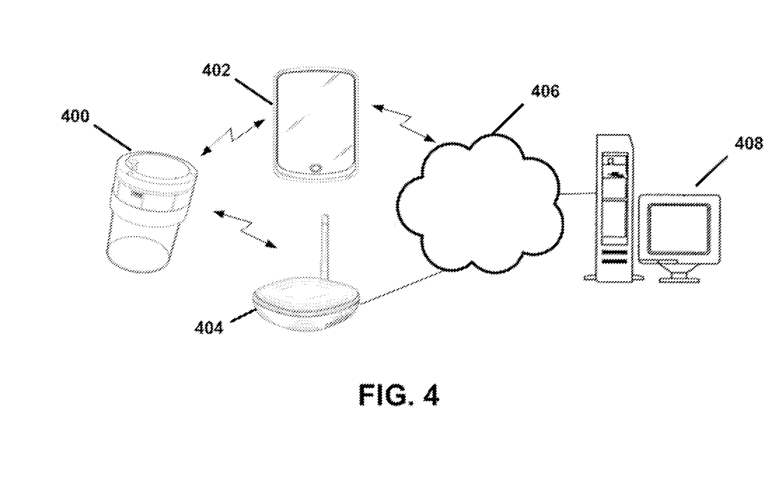

FIG. 4 captures the topology diagram of the fluid analyzer system. The fluid analyzer apparatus 400 utilizes a low output power wireless communication technology such as Bluetooth, Wi-Fi or IEEE 802.15.4 in order to communicate with mobile device 402 or with router 404. It communicates with mobile device 402 or router 404 and ultimately server 408 using utilizing Internet and Internet of Things networking and security technologies such as 6lowpan, RPL routing, COAP web resources and PANA/EAP and DTLS security constructs and suites.

Mobile device 402 or router 404 communicate with server 408 over an IPv4 of IPv6 enabled wide area infrastructure 406 such as a private of public intranet or the Internet.

Mobile device 402 is a smart phone or a tablet running an application that detects the type of chemical pads and electronic sensors cartridge utilized, and allows the user to visualize, interpret, store and trend the data received. The application collects and classifies the sensors readings based on sensors types, test subject, timestamp and location, and various user input, and processes this data to generate a set of results that can be easily understood by users without requiring a medical or engineering degree.

Server 408 hosts an application that allows the end user or third parties to manage the electronic reader 400 and access, store, visualize, trend, analyze, share, and export the data received from the electronic reader 400 and the application running on mobile device 402.

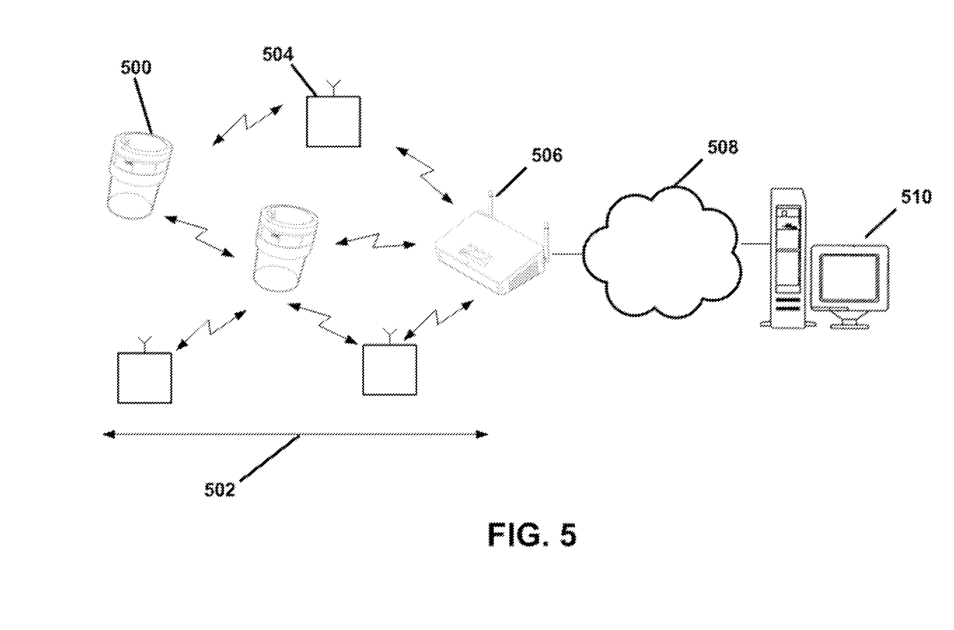

FIG. 5 is a topology diagram of the fluid analyzer system where the electronic reader 500 communicates with other wireless nodes that are part of a multi-hop mesh network. The wireless mesh nodes 504 and electronic readers 500 are devices that are part of the same home or local area network 502. Wireless mesh nodes such as 504 are devices engaged in other applications including but not limited to home and building automation. The electronic readers such as 500 and the wireless mesh nodes such as 504 communicate with server 510 over an IPv4 of IPv6 enabled wide area infrastructure 508 such as a private of public intranet or the Internet.

### INDUSTRIAL APPLICABILITY

Since the fluid analyzer apparatus can be used to measure parameters of interest of different fluids it can be used in a wide variety of applications by utilizing various cartridges that host different configurations of reagent pads and sensing features.

When utilized in the analysis of various bodily fluids, the invention is a versatile tool for pre-emptive screening for various diseases as well as monitoring of chronic conditions. It eliminates time consuming and costly trips to the doctor's office by providing instantaneous screening results in the comfort of the home or on the go. The invention can also be used in remote locations with no access to modern medical equipment and offers an accurate and cost effective way to test individuals and populations for various health parameters, and record the test results in a secure and private manner on a local device or on private and public servers.

When the sample fluid analyzed is urine the invention can be used for urinalysis, drug screening, fertility and pregnancy tests. When used in conjunction with a urinalysis cartridge physical properties measured are urine clarity, turbidity, color and temperature. Urine chemical composition parameters measured using reagent pads include but are not limited to nitrites, leukocytes, glucose, pH, protein, ketones, specific gravity, blood, bilirubin and urobilinogen.

When used in conjunction with a nutritional intake cartridge it can measure the intake of sodium, various proteins and sugars.

When used in conjunction with a drug screening cartridge it measures the temperature of the urine and is detects if the subject tested has been using illegal drugs.

The invention can also be used in the analysis of water samples collected from swimming pools, waste water treatment centers, wild water sources, and groundwater and potable water sources. For example a cartridge that is used in monitoring swimming pool water quality includes but is not limited to reading the levels of free chlorine, alkalinity, pH, cyanuric acid, phosphates and magnesium.

1. A handheld, portable fluid analyzer apparatus that is composed of:
an electronic reader, said electronic reader hosting a plurality of sensors and sensing methods that measure various parameters without coming in contact with the fluid, where said same reader can analyze various types of fluids such as urine or water and transmit the data wirelessly to a server;
a cup used to collect and contain the fluid sample outfitted with a cartridge, said cartridge allowing the reader to measure various parameters without coming in contact with the fluid.

2. A fluid analyzer apparatus as recited in claim 1, wherein said electronic reader includes a light emitting source and integrated color sensors that detect changes in color and wherein said cartridge is outfitted with chemical reagent pads that change color following contact with the fluid.

3. A fluid analyzer apparatus as recited in claim 1, wherein said electronic reader includes an integrated infrared sensor that measures the temperature of the fluid and wherein said cartridge is outfitted with a transparent window through which the fluid sample is visible.

4. A fluid analyzer apparatus as recited in claim 1, wherein said electronic reader includes an integrated light emitting source and detector used to measure the turbidity of the fluid and wherein said cartridge is outfitted with a fluid compartment that traps a small sample of fluid and provides a reflective surface.

5. A fluid analyzer apparatus as recited in claim 1, wherein said electronic reader includes embedded contacts used to measure the conductivity of the fluid and wherein said cartridge hosts integrated electrode contacts that come in contact with the fluid and the reader contacts.

6. A fluid analyzer apparatus as recited in claim 1, wherein said electronic reader includes a CCD or CMOS image sensor.

7. A fluid analyzer apparatus as recited in claim 1, wherein said electronic reader communicates wirelessly point-to-point with a mobile device that is connected to an IPv4 or Ipv6 enabled wide area communication infrastructure.

8. A fluid analyzer apparatus as recited in claim 1, wherein said electronic reader communicates wirelessly point-to-point with a stationary router that is connected to an IPv4 or Ipv6 enabled wide area communication infrastructure.

9. A fluid analyzer apparatus as recited in claim 1, wherein said electronic reader communicates wirelessly with other wireless devices that are part of a multi-hop mesh network that is connected to an IPv4 or Ipv6 enabled wide area communication infrastructure via one or multiple gateways.

10. A system comprised of the fluid analyzer apparatus recited in claim 7 and:
a mobile device that hosts a software application that relays data between the apparatus and a server and is also used to visualize, store, trend and analyze the data received from the apparatus;
a server that hosts an application that allows users to manage the devices and visualize, store, trend and analyze the data received and allows other third party applications to access the data via application specific software interfaces.

11. A system comprised of the fluid analyzer apparatus recited in claim 8 and:
a router, wherein said router relays data between the apparatus and a server;
a server that hosts an application that allows users to manage the devices and visualize, store, trend and analyze the data received and allows other third party applications to access the data via application specific software interfaces.

12. A system comprised of the fluid analyzer apparatus recited in claim 9 and:
a gateway, wherein aid gateway manages a multi-hop, wireless mesh network and relays data between the apparatus and a server;
a server that hosts an application that allows users to manage the devices and visualize, store, trend and analyze the data received and allows other third party applications to access the data via application specific software interfaces.
